(19) United States
(12) Patent Application Publication
(10) Pub. No.: US 2026/0151923 A1
(43) Pub. Date: Jun. 4, 2026

(54) COLLABORATIVE ROBOT FOR HAZARDOUS ENVIRONMENTS

(71) Applicant: A.I. Automation Inc., Landrum, SC (US)

(72) Inventor: Michael Kreps, Landrum, SC (US)

(73) Assignee: A.I. Automation Inc., Landrum, SC (US)

(21) Appl. No.: 19/348,444

(22) Filed: Oct. 2, 2025

Related U.S. Application Data
(60) Provisional application No. 63/705,810, filed on Oct. 10, 2024.
(60) Provisional application No. 63/763,979, filed on Feb. 27, 2025.

(51) Int. Cl. B25J 19/00; B25J 11/00; B25J 17/00; B25J 19/06

(52) U.S. Cl. CPC B25J 19/0083; B25J 11/005; B25J 11/0075; B25J 17/00; B25J 19/0079; B25J 19/061

(57) ABSTRACT

A scaling ring converts a collaborative robot to a HAZREGCOM Cobot for use in Class 1. Division 2 environments and includes a warning system that sends alerts of a failure condition in the Cobot.

### CROSS REFERENCE TO RELATED APPLICATIONS

This utility patent application claims benefit of U.S. Provisional Patent Application Ser. No. 63/705,810 filed in the United States Patent and Trademark Office (“USPTO”) on Oct. 10, 2024, and U.S. Provisional Patent Application Ser. No. 63/763,979 filed in the USPTO on Feb. 27, 2025, both of which are incorporated in their entireties by reference thereto.

### BACKGROUND OF THE DISCLOSURE

Robots have been used in manufacturing and assembly plants for decades. More recently, robots have been adapted to finer tasks and made more robust for industrial automation such as additive manufacturing, material handling, packaging, and loading. However, known systems cannot be used in environments susceptible to emissions and gas leaks that may result in explosion or fire.

A need exists for a sealed robotic system that can be safely used in hazardous environments.

### BRIEF SUMMARY OF THE DISCLOSURE

The present disclosure is directed in general to a sealed robotic system for use in hazardous environments. Further, the systems disclosed herein may contain a warning system, such as audible alerts, to warn a user of a system malfunction.

In one embodiment, a sealing ring or gasket is provided to convert collaborative robots for use in Class 1, Division 2 environments. The sealing ring may include multiple connection points, such as ten, and may be installed between a base and a joint of a collaborative robot. Once installed, the sealing ring maintains air pressurization, and the robot can be employed in otherwise hazardous environments, such as a paint booth, a welding environment, a garage containing flammable gases or materials, and combinations thereof.

In a further embodiment, a warning system is provided with a collaborative robot to alert a user of a hazardous leak, robotic failure, or other conditions. The warning system may be an audible alarm with various tones, bells, and/or automated voice alerts, according to a detected condition.

In another aspect of the disclosure, a sealed collaborative robot system for converting collaborative robots for use in Class 1, Division 2 environments may include a sealing gasket defining a plurality of connection points, the connection points of the sealing gasket being, for example, 1-inch in thickness, having 3.75 inches surface-to-surface depth, and being 15 inches wide, the sealing gasket being manufactured from fire and spark resistant materials with other sizes being described herein. The fire and spark resistant materials may include fluoroelastomers, butyl, vinyl, polyethylene and combinations thereof.

In this aspect, the sealing gasket may be inserted or positioned between a base and a joint of a collaborative robot. The sealing gasket can maintain air pressurization, and more particularly, can maintain air pressurization for use in a paint booth, a welding environment, a garage containing flammable gases or materials, and combinations thereof.

The sealed collaborative robot system in this aspect of the disclosure may also include a warning system to audibly warn of a hazardous condition, a robot failure, and combinations thereof.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 is an elevational view of an exemplary robot arm according to an aspect of the disclosure;

FIG. 2 shows a portion of the robot arm as in FIG. 1, particularly showing a partial joint and a seal ring gasket intended for sealing the joint according to a further aspect of the disclosure;

FIG. 3 is a perspective view of different sizes of seal ring gaskets and a disassembled portion of the robot arm as in FIG. 1, one of the seal ring gaskets being sized for the joint of the robot arm;

FIG. 4A is a partial perspective view of the disassembled portion of the robot arm as in FIG. 3 showing the seal ring gasket installed thereon;

FIG. 4B is a perspective view of the robot arm with seal ring gasket as in FIG. 4A being reassembled, or being readied for disassembly;

FIG. 5A is an elevational view of an exemplary seal ring gasket as in FIG. 3, particularly showing a section of the gasket in a magnified inset;

FIG. 5B is a perspective view of the seal ring gasket as in FIG. 5A;

FIG. 5C is a plan view of the seal ring gasket as in FIGS. 5A and 5B, particularly showing a section of the gasket in a magnified inset;

FIG. 6A is an elevational view of another exemplary seal ring gasket as in FIG. 3, particularly showing a section of the gasket in a magnified inset;

FIG. 6B is a perspective view of the seal ring gasket as in FIG. 6A;

FIG. 6C is a plan view of the seal ring gasket as in FIGS. 6A and 6B, particularly showing a section of the gasket in a magnified inset;

FIG. 7A is an elevational view of yet another exemplary seal ring gasket as in FIG. 3, particularly showing a section of the gasket in a magnified inset;

FIG. 7B is a perspective view of the seal ring gasket as in FIG. 7A;

FIG. 7C is a plan view of the seal ring gasket as in FIGS. 7A and 7B, particularly showing a section of the gasket in a magnified inset;

FIG. 8A is a plan view of a further exemplary seal ring gasket as may be used in various embodiments of the disclosure, particularly showing a section of the gasket in a magnified inset;

FIG. 8B is a perspective view of the seal ring gasket as in FIG. 8A;

FIG. 8C is an elevational view of the seal ring gasket as in FIGS. 8A and 8B, particularly showing a section of the gasket in a magnified inset;

FIG. 9A is a plan view of a further exemplary seal ring gasket as may be used in various embodiments of the disclosure, particularly showing a section of the gasket in a magnified inset;

FIG. 9B is a perspective view of the seal ring gasket as in FIG. 9A;

FIG. 9C is an elevational view of the seal ring gasket as in FIGS. 9A and 9B, particularly showing a section of the gasket in a magnified inset;

FIG. 10A is a plan view of an exemplary seal ring gasket similar to FIG. 9A, particularly showing a section of the gasket in a magnified inset;

FIG. 10B is a perspective view of the seal ring gasket as in FIG. 10A;

FIG. 10C is an elevational view of the seal ring gasket as in FIGS. 10A and 10B, particularly showing a section of the gasket in a magnified inset;

FIG. 11A is a plan view of another exemplary seal ring gasket as may be used in embodiments of the disclosure, particularly showing a section of the gasket in a magnified inset;

FIG. 11B is a perspective view of the seal ring gasket as in FIG. 11A;

FIG. 11C is an elevational view of the seal ring gasket as in FIGS. 11A and 11B, particularly showing a section of the gasket in a magnified inset;

FIGS. 12A and 12B are plan views of another exemplary seal ring gasket as may be used in embodiments of the disclosure, particularly showing a section of the gasket in a magnified inset in FIG. 12A;

FIG. 12C is an elevational view of the seal ring gasket as in FIG. 12A;

FIG. 13A is a plan view of another exemplary seal ring gasket, particularly showing a section of the gasket in a magnified inset;

FIG. 13B is a perspective view of the seal ring gasket as in FIG. 13A;

FIG. 13C is an elevational view of the seal ring gasket as in FIGS. 13A and 13B, particularly showing a section of the gasket in a magnified inset;

FIG. 14A is a perspective view of another exemplary robot arm according to an aspect of the disclosure; and

FIG. 14B is an exploded view of the robot arm as in FIG. 14A, particularly showing exemplary seal ring gaskets according to the disclosure.

### DETAILED DESCRIPTION OF THE DISCLOSURE

As required, detailed embodiments are disclosed herein; however, the disclosed embodiments are merely examples and may be embodied in various forms. Therefore, specific structural and functional details disclosed herein are not to be interpreted as limiting, but merely as a basis for the claims and as a representative basis for teaching one skilled in the art to variously employ the exemplary embodiments of the present disclosure, as well as their equivalents.

Unless defined otherwise, all technical, engineering, and scientific terms used herein have the same meaning as is commonly understood by one of ordinary skill in the art to which this disclosure belongs. In the event that there is a plurality of definitions for a term, phrase, or acronym herein, those in this section prevail unless stated otherwise.

Wherever the phrase “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

“Class 1, Division 2” relates to hazardous environments or locations as defined in Section 1910.307 of OSHA regulations.

Collaborative Robots or “COBOTS” that comply with Class 1, Division 2 (“Class 1, Div 2”) regulations are referred to herein as “hazardous regulation compliant” or “HAZREGCOM” Cobots.

The term “ranges” includes all combinations of sub-ranges. For instance, a range from 100-200 includes ranges from, e.g., 110 to 150, 170 to 190, and 153 to 162. Similarly, “limits” means all sub-limit combinations, e.g., a limit of up to 7 also includes a limit of up to 5, up to 3, and up to 4.5.

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, et cetera. Thus, for example, “a device having components a, b, and c” means that the device includes at least components a, b, and c. Similarly, a phrase such as: “a method involving a, b, and c” means that the method includes at least steps a, b, and c.

Where a list of alternative component terms is used, e.g., “a structure such as ‘a,’ ‘b,’ ‘c,’ ‘d’ or the like,” or “a or b,” such lists and alternative terms provide meaning and context for the sake of illustration, unless indicated otherwise. Also, relative terms such as “first,” “second,” “third,” “front,” and “rear” are intended to identify or distinguish one component or feature from another similar component or feature, unless indicated otherwise herein.

Unless the context clearly requires otherwise, throughout the description and the claims, the words “comprise,” “comprising,” and the like are to be construed in an inclusive sense as opposed to an exclusive or exhaustive sense; in the sense of “including, but not limited to.”

The various embodiments of the disclosure and/or equivalents falling within the scope of present disclosure overcome or ameliorate at least one of the disadvantages of the prior art or provide a useful alternative.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

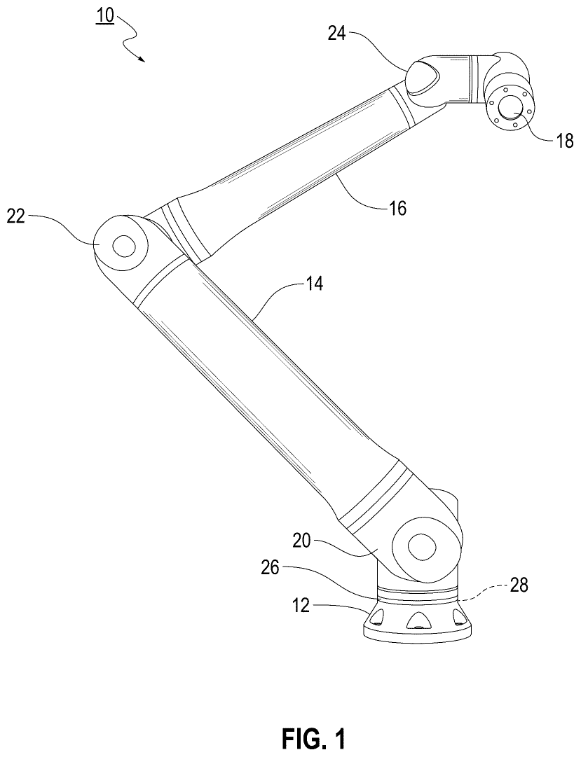

Turning now to FIG. 1, a collaborative robot (“Cobot”) such as a Cobot provided by Universal Robotics® is broadly designated by element number 10 and includes a stationary stand or base 12 that may be arranged at or near a workstation for welding, painting, tooling, packaging, or the like. The Cobot 10 is hazardous regulation compliant (Class 1, Division 2), i.e., “HAZREGCOM,” and may have a first arm 14, a second arm 16, and an attachment head or hand 18 for receiving welding equipment or the like (not shown). Here, swivel joints 20, 22, 24 are provided respectively between the arms 14, 16, and head 18 to permit movement of the HAZREGCOM Cobot 10 in multiple axes.

As further shown in FIG. 1, a sealed area 26 is located between the base 12 and the swivel joint 20 within which a sealing or seal ring or gasket 28 is installed. Gaskets 28 may be installed at all swivel joints 20, 22, 24. The sealing gasket 28 converts standard cobots from general usage to a Class 1 Division 2 compliant unit that can be utilized in hazardous environments such as paint booths.

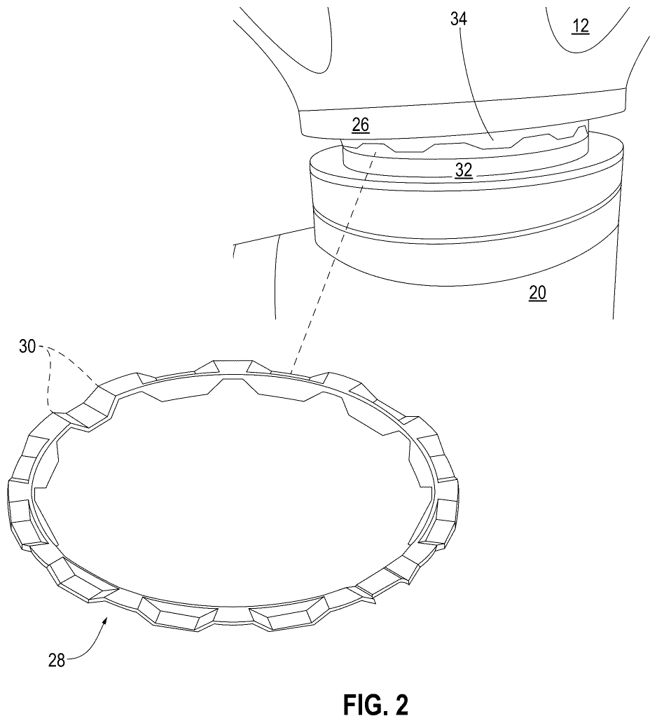

Turning to FIG. 2, the sealing gasket 28 includes multiple connection points or seal features 30 that, when installed, maintain air pressurization within the Cobot 10 such as in FIG. 1. More particularly, a portion of the base 12 and the swivel joint 20 are shown separated to reveal a joint area 32 and teeth 34. In this example, the sealing gasket 28 has between eight (8) to twelve (12), more particularly, ten (10) connection points that complement or correspond to the teeth 34, as further explained below.

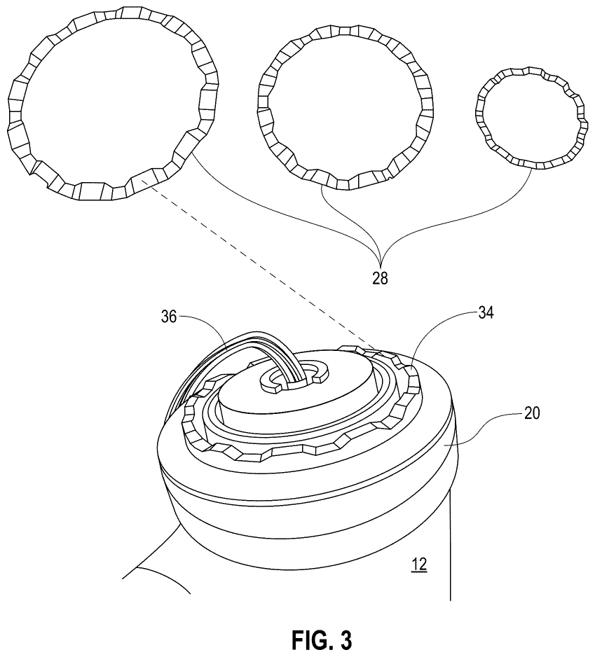

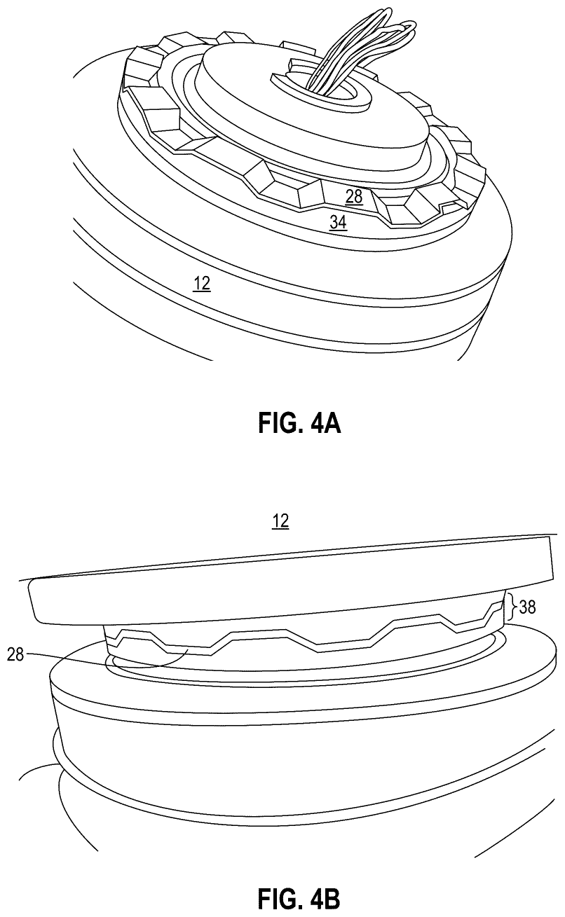

With reference to FIGS. 3, 4A, and 4B, an exemplary installation of the sealing gasket 28 is shown. FIG. 3 particularly shows multiple sizes of sealing gaskets 28, e.g., three sizes, which may be employed with assorted sizes of Cobots 10 as in FIG. 1. For instance, a UR20 from Universal Robotics® is a collaborative robot having six (6) axes of movement, a 1750 mm reach, 25 kg payload, while a UR30 has a 1300 mm reach capable of handling a 30 kg payload, which can be fitted with sealing gaskets 28. More particularly, FIG. 3 shows the joint 20 separated from an arm (see, e.g., arm 14 in FIG. 1) such that electrical wiring 36 is exposed and the teeth 34 project from the base 12 over which the appropriate sized sealing gasket 28 will be placed as shown in FIG. 4A. FIG. 4B shows a seal 38 created by the sealing gasket 28.

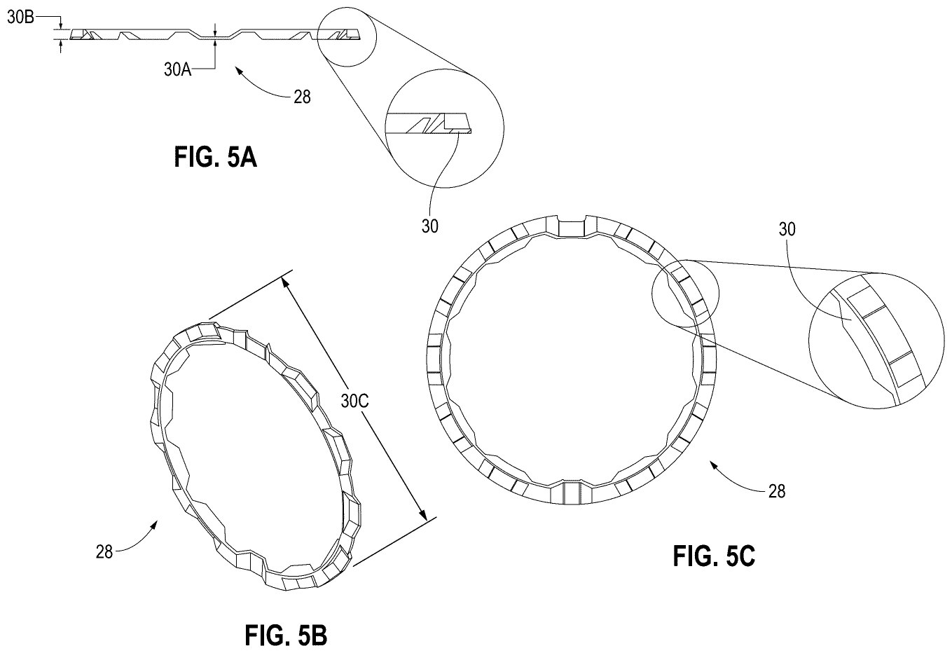

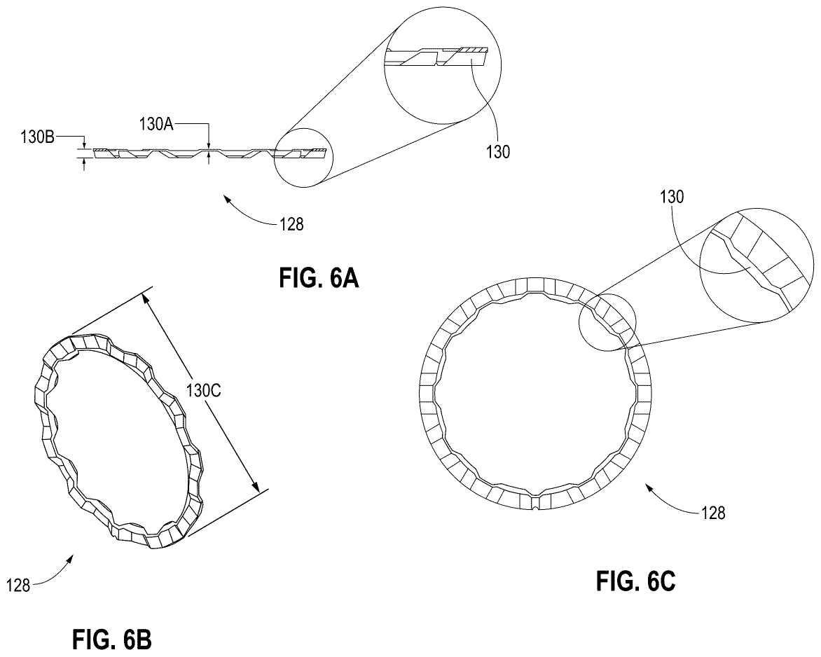

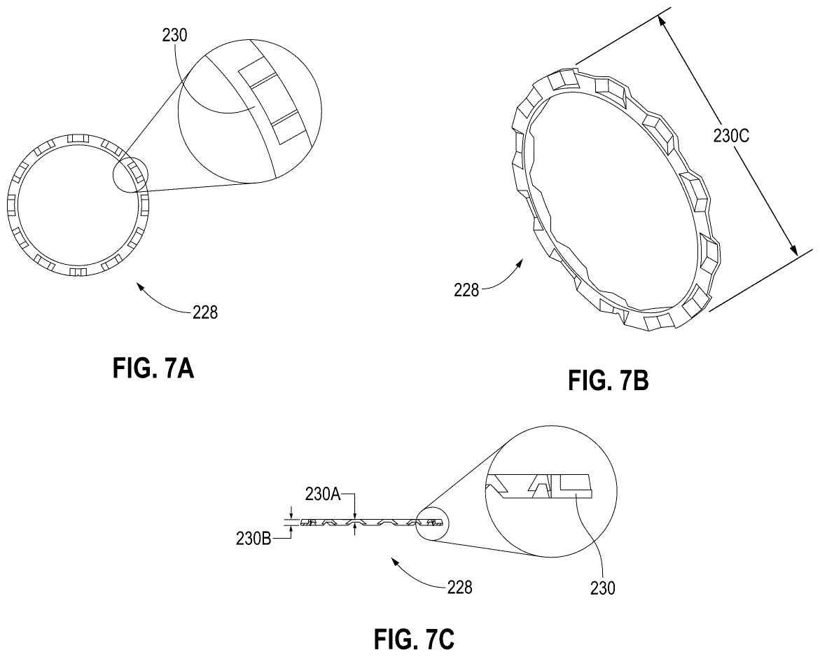

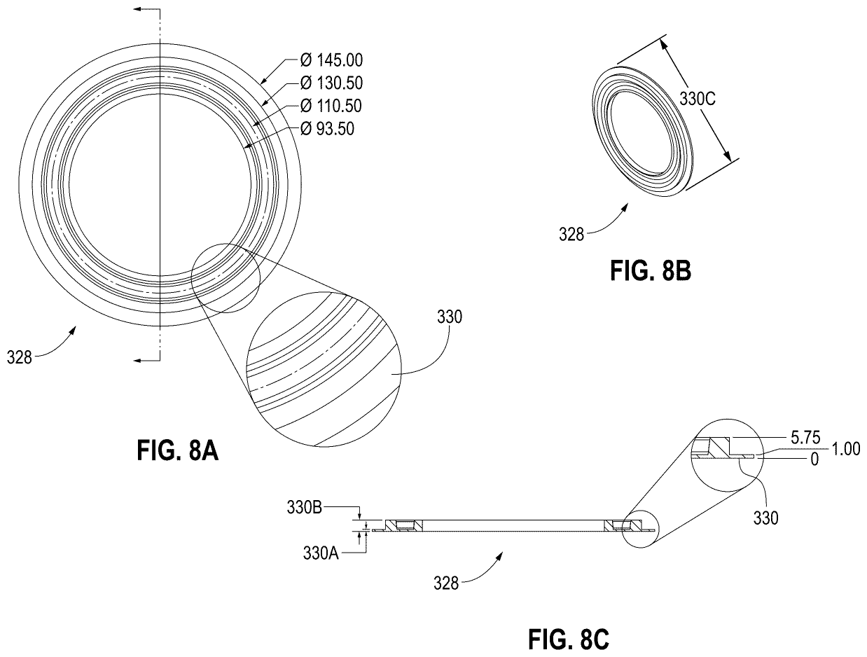

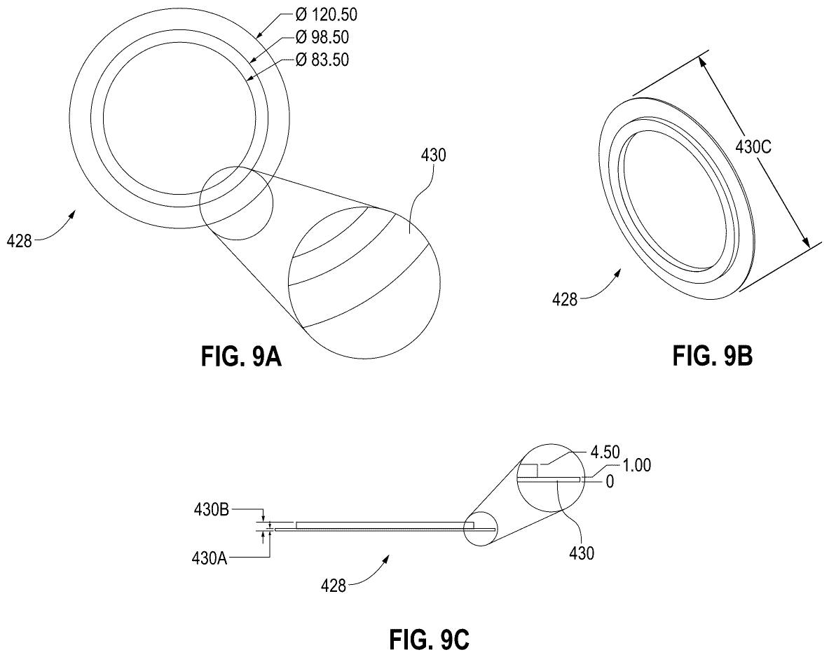

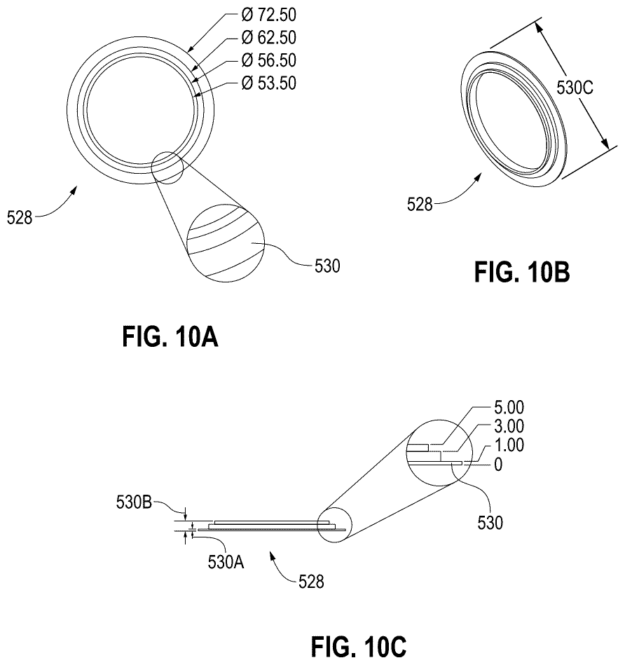

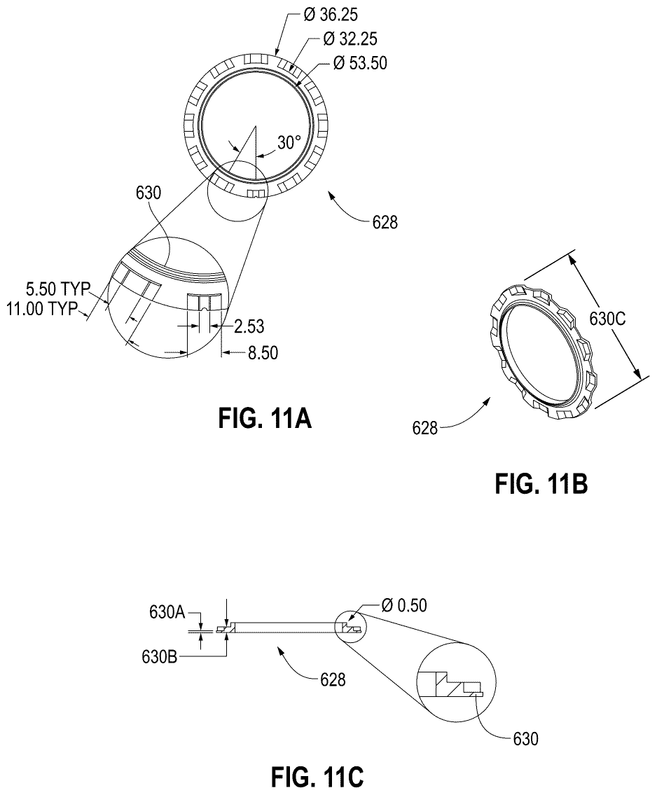

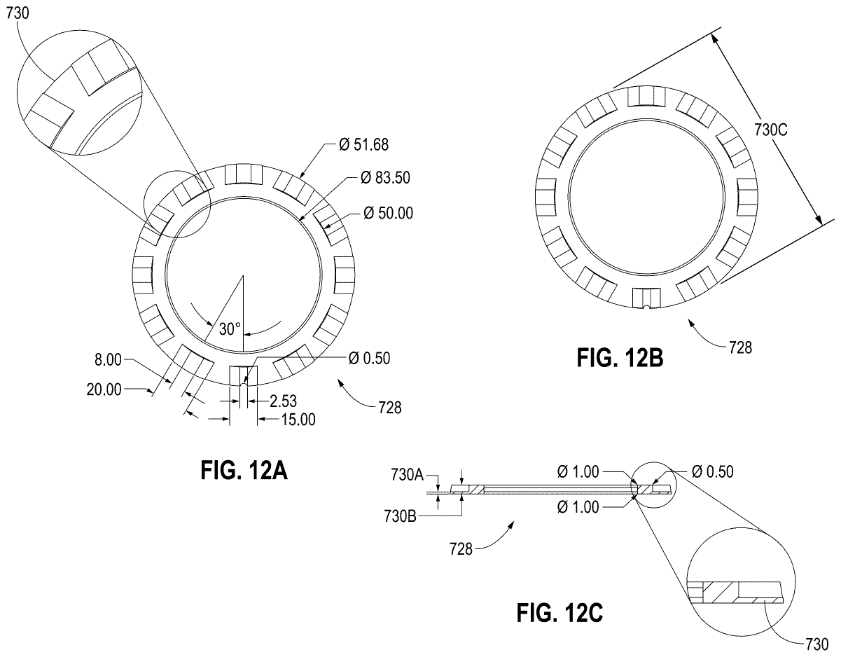

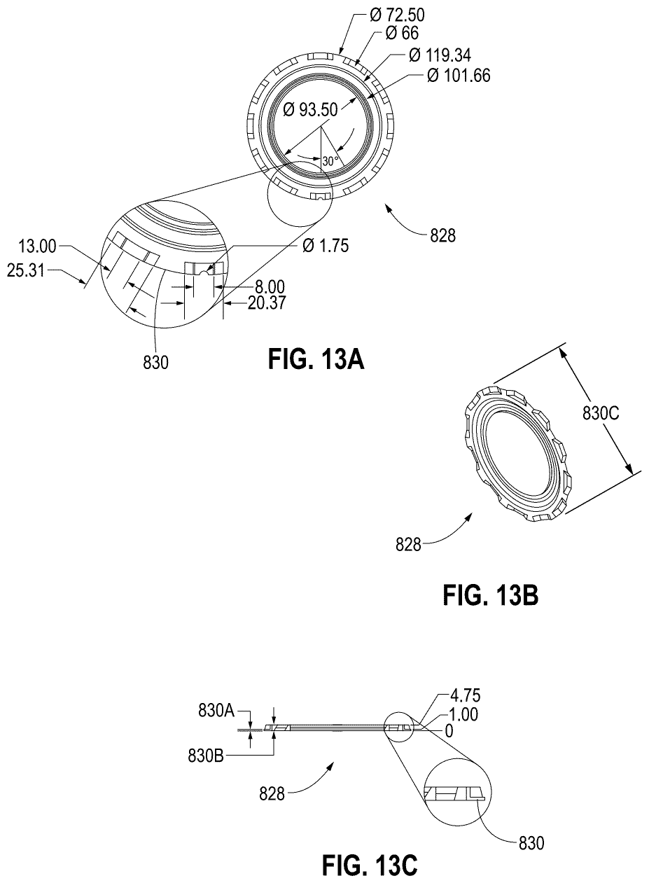

Turning now to FIGS. 5A through 13C, assorted sizes, shapes, and dimensions of exemplary sealing gaskets 28, 128, 228, 328, 428, 528, 628, 728, and 828 are shown. For instance, a connection point 30 of the gasket 28 in FIG. 5A may have dimensions of ½ inch to 2 inches in thickness, a surface-to-surface depth of 2.5 inches to 4.75 inches, and 12 inches to 18 inches in width, more particularly, a 1-inch-thickness, a surface-to-surface depth of 3.75 inches and a width of 15 inches, as indicated by respective element numbers 30A, 30B, and 30C. Similarly, connection points 130, 230, 330, 430, 530, 630, 730, and 830 are shown respectively in FIGS. 6A through 13C. To endure hazardous environments that may be explosive, flammable, and the like, the sealing gaskets 28, 128, 228, 328, 428, 528, 628, 728, and 828 may be manufactured from fire and spark resistant materials such as Viton™ brand fluoroelastomers, butyl, vinyl, polyethylene, and similar materials, and combinations thereof. Still further, to accommodate various teeth (such as teeth 34 in FIG. 3), the various gaskets 28, 128, 228, 328, 428, 528, 628, 728, and 828 may have a variety of thicknesses and angles indicated by Ø as shown in FIGS. 6A through 13C.

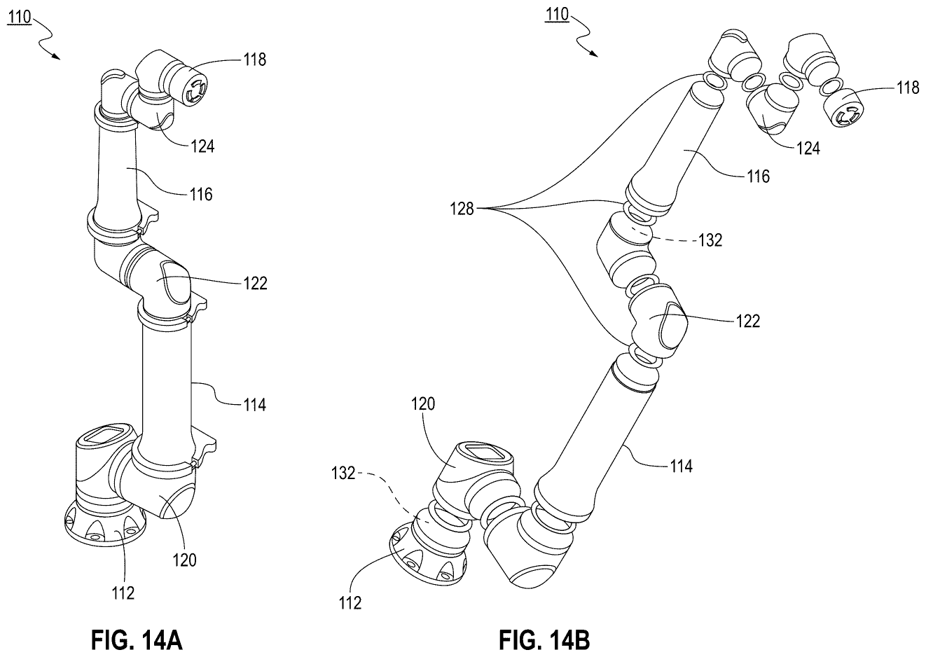

With reference to FIGS. 14A and 14B, another HAZREGCOM Cobot is broadly designated by element number 110 and includes a stationary stand or base 112 that may be arranged at or near a workstation for welding, packaging, or the like. The Cobot 110, such as model 15XP with a 17.5 kg payload and 1300 mm reach provided by Universal Robotics®, may have a first arm 114, a second arm 116, and an attachment head or hand 118 for receiving welding equipment or the like (not shown). Here, swivel joints 120, 122, 124 are provided respectively between the arms 114, 116, and head 118 to permit movement of the Cobot 110 in multiple axes.

As shown most clearly in the exploded view of FIG. 14B, exemplary sealing gaskets 128 according to the present disclosure, such as those shown in detail in FIGS. 5A through 13C, may be installed at joint areas 132 to convert, e.g., the standard Cobot model 15XP from general usage to a Class 1 Div 2 compliant unit, i.e., a HAZREGCOM Cobot 110, that can be utilized in hazardous environments such as paint booths. The sealing gaskets 128 may also be used in other Cobots, such as model 8XP with an 8 kg payload and 1750 mm reach, and model 30XP with a 35 kg payload and 1300 mm reach, to convert those and other standard Cobots to Class 1 Div 2 compliant units.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

By way of example and not of limitation, exemplary embodiments as disclosed herein may include but are not limited to:

EMBODIMENT 1: A system for converting collaborative robots for use in Class 1, Division 2 environments.

EMBODIMENT 2: The system as in Embodiment 1, further comprising a sealing ring defining a plurality of connection points.

EMBODIMENT 3: The system as in Embodiment 2, wherein the sealing ring is disposed between a base and a joint of a collaborative robot or between a plurality of joints.

EMBODIMENT 4: The system as in Embodiments 2 or 3, wherein the sealing ring maintains air pressurization.

EMBODIMENT 5: The system as in Embodiments 2 through 4, wherein the sealing ring maintains air pressurization for use in a paint booth, a welding environment, a garage containing flammable elements such as gases or materials, and combinations thereof.

EMBODIMENT 6: The system as in any of the foregoing Embodiments, further comprising a warning system configured to audibly warn of a hazardous condition, a robot failure, and combinations thereof.

EMBODIMENT 7: A sealed collaborative robot system for converting collaborative robots for use in Class 1, Division 2 environments, the sealed collaborative robot system comprising a sealing gasket defining between eight to twelve connection points, the connection points of the sealing gasket being ½ inch to 2 inches in thickness, having surface-to-surface depth of 2.5 inches to 4.75 inches, and being 12 inches to 18 inches in width, the sealing gasket being manufactured from fire and spark resistant fluoroelastomers, butyl, vinyl, or polyethylene.

1. A sealed collaborative robot system for converting collaborative robots for use in Class 1, Division 2 environments, the sealed collaborative robot system comprising:
a sealing gasket defining a plurality of connection points, the connection points of the sealing gasket being 1-inch in thickness, having 3.75 inches surface-to-surface depth, and being 15 inches wide, the sealing gasket being manufactured from fire and spark resistant materials.

2. The sealed collaborative robot system as in claim 1, wherein the sealing gasket is disposed between a base and a joint of a collaborative robot.

3. The sealed collaborative robot system as in claim 1, wherein the connection points are at least ten connection points.

4. The sealed collaborative robot system as in claim 1, wherein the fire and spark resistant materials include fluoroelastomers, butyl, vinyl, polyethylene, and combinations thereof.

5. The sealed collaborative robot system as in claim 1, wherein the sealing gasket maintains air pressurization in a HAZREGCOM Cobot.

6. The sealed collaborative robot system as in claim 1, wherein the sealing gasket maintains air pressurization in a HAZREGCOM Cobot for use in a paint booth, a welding environment, a garage containing flammable gases or materials, and combinations thereof.

7. The sealed collaborative robot system as in claim 1, further comprising a warning system configured to audibly warn of a hazardous condition, a HAZREGCOM Cobot failure, and combinations thereof.

8. A sealed collaborative robot system for converting collaborative robots for use in Class 1, Division 2 environments, the sealed collaborative robot system comprising:
a sealing gasket defining a plurality of connection points, the connection points of the sealing gasket being ½ inch to 2 inches in thickness, having surface-to-surface depth of 2.5 inches to 4.75 inches, and being 12 inches to 18 inches in width, the sealing gasket being manufactured from fire and spark resistant materials.

9. The sealed collaborative robot system as in claim 8, wherein the sealing gasket is disposed between a base and a joint of a collaborative robot.

10. The sealed collaborative robot system as in claim 8, wherein the sealing gasket is disposed between a plurality of joints of a collaborative robot.

11. The sealed collaborative robot system as in claim 8, wherein the connection points are at eight to twelve connection points.

12. The sealed collaborative robot system as in claim 8, wherein the fire and spark resistant materials include fluoroelastomers, butyl, vinyl, polyethylene, and combinations thereof.

13. The sealed collaborative robot system as in claim 8, wherein the sealing gasket maintains air pressurization in a HAZREGCOM Cobot.

14. The sealed collaborative robot system as in claim 8, wherein the sealing gasket maintains air pressurization in a HAZREGCOM Cobot for use in a paint booth, a welding environment, a garage containing flammable gases or materials, and combinations thereof.

15. A sealed collaborative robot system for converting collaborative robots for use in Class 1, Division 2 environments, the sealed collaborative robot system comprising:
a sealing gasket defining between eight to twelve connection points, the connection points of the sealing gasket being ½ inch to 2 inches in thickness, having surface-to-surface depth of 2.5 inches to 4.75 inches, and being 12 inches to 18 inches in width, the sealing gasket being manufactured from fire and spark resistant fluoroelastomers, butyl, vinyl, or polyethylene.

16. The sealed collaborative robot system as in claim 15, wherein the sealing gasket maintains air pressurization in a HAZREGCOM Cobot in an explosively hazardous environment.

17. The sealed collaborative robot system as in claim 15, wherein the sealing gasket maintains air pressurization in a HAZREGCOM Cobot in a paint booth, a welding environment, or a garage containing flammable elements.
